(19) United States
(12) Patent Application Publication
(10) Pub. No.: US 2026/0365100 A1
(43) Pub. Date: Nov. 19, 2026

(54) BRACKETS AND LAMP HOUSINGS FOR PEDESTRIAN SAFETY

(71) Applicant: Rivian IP Holdings, LLC, Irvine, CA (US)

(72) Inventors: Baha Jehad Husni EL FAR, Irvine, CA (US); Daniel CALDER, Rancho Mission Viejo, CA (US); Siobhan Marie CASEY, Newport Beach, CA (US); Ignacio PEON ZAPATA, Irvine, CA (US); Shubham Prakash KULKARNI, Irvine, CA (US); Stephen KOWAL, Allen Park, MI (US)

(21) Appl. No.: 19/208,479

(22) Filed: May 14, 2025

(51) Int. Cl. B60Q 1/04; B60R 21/34

(52) U.S. Cl. CPC B60Q 1/0495; B60Q 1/0441; B60R 21/34; B60R 2021/343

(57) ABSTRACT

A vehicle includes a carrier for lamps, with the carrier designed to minimize impact to pedestrians. A bracket may secure with the carrier such that the bracket and the carrier carry a lamp housing for a lamp. Each of the bracket and the lamp housing includes tabs designed to break in response to an applied force to the lamp and/or the lamp housing, thereby permitting movement of the lamp and the lamp housing relative to the carrier and the bracket. When the applied force is provided by a pedestrian, the movement of the lamp and the lamp housing may minimize impact to the pedestrian.

### INTRODUCTION

This application is directed to lamps for vehicles, and more particularly, to lamps designed to move in response to an applied force.

### SUMMARY

The subject technology is directed to components (e.g., brackets, lamp housing) with features designed to break and allow components such as a lamp and a lamp housing to move relative to other components.

In one or more aspects of the present disclosure, an apparatus is described. The apparatus may include a bracket. The bracket may include a first portion that includes a first tab configured to receive a first fastener to couple a lamp housing with the first portion. The bracket may further include a second portion extending from the first portion. The second portion configured to couple with a carrier. In response to an applied force, the first tab is configured to break and permit movement of the lamp housing relative to the first portion and the second portion.

The first portion may be perpendicular with respect to the second portion. The first tab may include an opening to receive the first fastener. The first tab may be i) perpendicular with respect to the first portion and ii) parallel with respect to the second portion. The bracket may further include a second tab extending from the first portion. The bracket may further include a third portion extending from the first portion and separate from the second portion. The second tab may be i) perpendicular with respect to the first portion and ii) parallel with respect to the third portion.

The first portion may include one or more ribs. The first tab and the second portion may define a separation. In response to the applied force that causes the first tab to break, the separation defines a space for the movement of the lamp housing. The second portion may include an opening configured to receive a second fastener to secure the bracket with the carrier.

In one or more aspects of the present disclosure, a subassembly is described. The subassembly may include a bracket including a first tab. The subassembly may further include a lamp housing configured to couple with the bracket via a first fastener passing through the first tab, the lamp housing including a second tab. The subassembly may further include a carrier configured to couple with the bracket and hold the lamp housing. In response to an applied force, the first tab and the second tab are configured to break and permit movement of the lamp housing relative to the bracket.

The lamp housing may include a first wall. The lamp housing may further include an extension that extends from the first wall, the extension configured to couple with the first fastener. The lamp housing may further include a second wall separate from the first wall. The second tab may extend from the second wall.

The bracket may further include a first bracket portion. The first tab may extend from the first bracket portion. The bracket may further include a second bracket portion extending from the first bracket portion. The second tab may extend from the second bracket portion. The first bracket portion may be perpendicular with respect to the second bracket portion. The first tab may be perpendicular with respect to the first bracket portion. The first tab may be parallel with respect to the second bracket portion. The first bracket portion may include one or more ribs. The first tab may define a separation from the first bracket portion. In response to the applied force that causes the first tab and the second tab to break, the separation may define a space for the movement of the lamp housing.

In one or more aspects of the present disclosure, a vehicle is described. The vehicle may include a vehicle body. The vehicle may further include a bracket disposed in the vehicle body. The bracket may include a first tab. The vehicle may further include a lamp housing disposed in the vehicle body. The lamp housing may be configured to couple with the bracket via a first fastener passing through the first tab. The lamp housing may include a housing that includes a second tab. The vehicle may further include a carrier disposed in the vehicle body. The carry may be configured to couple with the bracket and hold the lamp housing. In response to an applied force, the first tab and the second tab are configured to break and permit movement of the lamp housing relative to the bracket.

The lamp housing may include a first wall. The lamp housing may further include an extension that extends from the first wall. The extension may be configured to couple with the first fastener. The lamp housing may include a second wall separate from the first wall. The second tab may from the second wall.

The vehicle may further include a lamp carried by the lamp housing. The vehicle may include an opening for the lamp. The bracket may further include a first bracket portion. The first tab may extend from the first bracket portion. The bracket may further include a second bracket portion extending from the first bracket portion. The second tab may extend from the second bracket portion.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a side view of an example of a vehicle, in accordance with one or more aspects of the present disclosure.

FIG. 2 illustrates a side view of an alternate example of a vehicle, in accordance with one or more aspects of the present disclosure.

FIG. 3 illustrates a front view of a vehicle, in accordance with aspects of the present disclosure.

FIG. 4 illustrates a perspective view of an example a carrier for lamps, in accordance with aspects of the present disclosure.

FIG. 5 illustrates a perspective view of an example a bracket for securing lamps of a vehicle, in accordance with aspects of the present disclosure.

FIG. 6 illustrates a partial perspective view of a carrier and a bracket coupled with the carrier, further showing relationships between the carrier and the bracket, in accordance with aspects of the present disclosure.

FIG. 7 illustrates a partial perspective view of the carrier and the bracket coupled with the carrier, further showing a portion of the bracket coupled with the carrier, in accordance with aspects of the present disclosure.

FIG. 8A illustrates a partial cross sectional view of a carrier and a bracket, further showing a lamp housing coupled with the carrier and the bracket, in accordance with aspects of the present disclosure.

FIG. 8B illustrates a partial cross sectional view of the carrier and the bracket shown in FIG. 8A, further showing movement of the lamp and the lamp housing based on an applied force, in accordance with aspects of the present disclosure.

FIG. 9 illustrates a perspective view of an example of a body used to absorb impact energy, in accordance with aspects of the present disclosure.

FIG. 10 illustrates a cross sectional view of the body shown in FIG. 9, taken along line 10-10, in accordance with aspects of the present disclosure.

FIG. 11 illustrates a partial cross sectional view of a lamp and a carrier, further showing a body positioned relative to the lamp, in accordance with aspects of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The present disclosure is directed to a bracket used to couple a lamp (e.g., center lamp) to a carrier, with the carrier designed to further carry lamps (e.g., headlamps). The bracket includes tabs used to couple the bracket with the center lamp. The tabs are designed to break in response to an applied force to the lamp, thereby allowing the lamp to move and reduce impact to a pedestrian (e.g., the source of the applied force). The center lamp may include a lamp housing that also includes tabs used to couple with the carrier and subsequently break in response to an applied force.

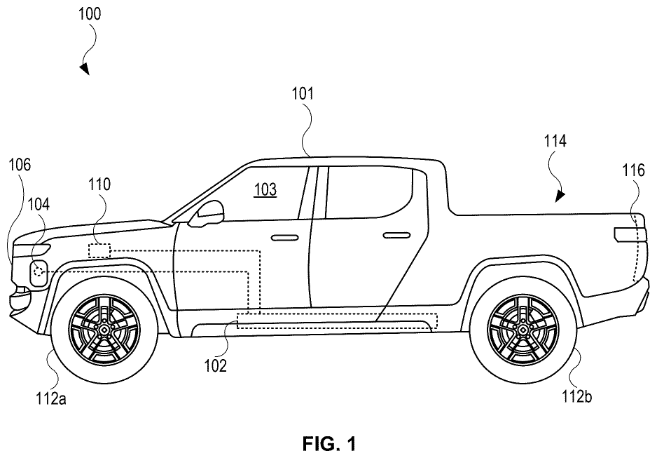

FIG. 1 illustrates a side view of an example of a vehicle 100, in accordance with one or more aspects of the present disclosure. In the example shown in FIG. 1, the vehicle 100 takes the form of a truck. Generally, the vehicle 100 may take the form of any motorized vehicle, including motorized vehicles with an internal combustion engine and/or one or more electric motors. Accordingly, other implementations of the vehicle 100 may include land-based vehicles, such as a car (e.g., sedan, hatchback), a van, or a commercial truck, as non-limiting examples.

The vehicle 100 may include a battery pack 102. The battery pack 102 may be carried by a vehicle body 101 of the vehicle 100, with the vehicle body 101 defining a cabin 103 that provides a space for passengers. The battery pack 102 may be coupled (e.g., electrically coupled) to one or more electrical systems of the vehicle 100 to provide power to the one or more electrical systems. For example, the vehicle 100 may include a port 104 (e.g., charge port) designed to receive a cable connector (not shown in FIG. 1) used to transmit power (e.g., alternating current (AC) power) that is converted to direct current (DC) power to charge the battery pack 102. The vehicle 100 may further include a front end 106 at which one or more lamps (shown below) are generally positioned.

As another exemplary electrical system, the vehicle 100 may include a drive unit 110, representative of one or more additional drive units of the vehicle 100. The battery pack 102 may couple to the drive unit 110. While the drive unit 110 is shown as generally being in the front of the vehicle 100, the drive unit 110 may be located in the rear of the vehicle 100. Further, when multiple drive units are used, at least one drive unit may be in the front of the vehicle 100 to drive the front wheels (e.g., wheel 112a), and at least one drive unit may be in the rear of the vehicle 100 to drive the rear wheels (e.g., wheel 112b). The drive unit 110 may include, for example, a motor, an inverter, a gear box, and a differential. In the example shown in FIG. 1, the drive unit 110 takes the form of an electric motor. In this regard, the drive unit 110 may use energy (e.g., electrical energy) stored in the battery pack 102 for propulsion in order to drive (e.g., rotationally drive) wheels of the vehicle 100.

The vehicle 100 may further include a bed 114 that may be used as a storage area for the vehicle 100. In order to access the bed 114, the vehicle 100 may further include a gate 116. Based on its position on the vehicle 100, the gate 116 may take the form of a closure, such as a rear gate or a tailgate. The gate 116 is designed to open, via rotation, thereby allowing further access to the bed 114.

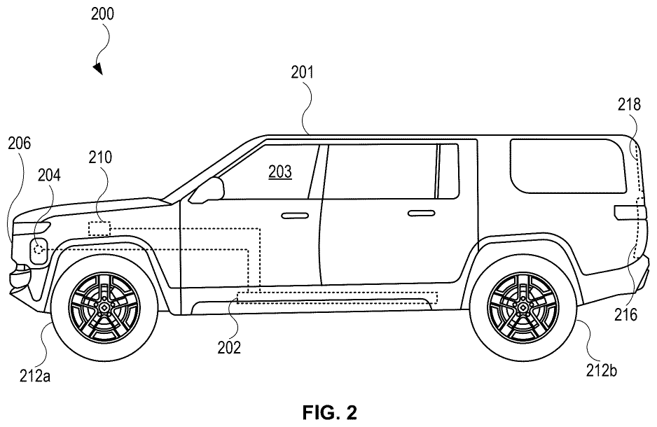

FIG. 2 illustrates a side view of an alternate example of a vehicle 200, in accordance with one or more aspects of the present disclosure. As shown, the vehicle 200 takes the form of a sport utility vehicle (SUV). The vehicle 200 may include several features shown and/or described for the vehicle 100 (shown in FIG. 1). For example, the vehicle 200 may include a vehicle body 201, a battery pack 202, a cabin 203, a port 204 (e.g., charge port), a front end 206, a drive unit 210 (representative of one or more additional drive units), a wheel 212a (representative of an additional front wheel), and a wheel 212b (representative of an additional rear wheel).

The cabin 203 of the vehicle 200 may extend to a rear portion of the vehicle 200. In order to access the rear portion of the cabin 203, the vehicle 200 may further include a gate 216. Based on its position on the vehicle 200, the gate 216 may take the form of a rear gate or a liftgate. The gate 216 is designed to open, via rotation, thereby allowing access to the cabin 203. Additionally, the vehicle 200 may include an enclosure 218. In one or more implementations, the enclosure 218 takes the form of a glass panel. Similar to the gate 216, the enclosure 218 is designed to open, via rotation, thereby allowing further access to the cabin 203.

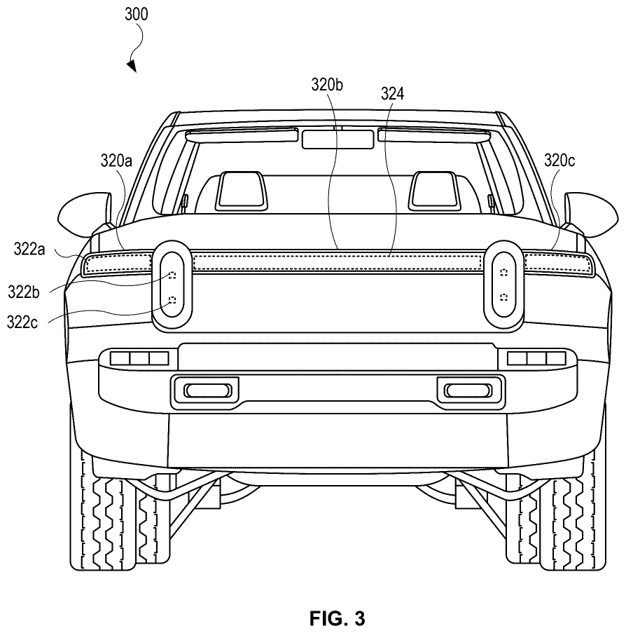

FIG. 3 illustrates a front view of a vehicle 300, in accordance with aspects of the present disclosure. Each of the vehicle 100 (shown in FIG. 1) and the vehicle 200 (shown in FIG. 2) may include any features shown and/or described herein for the vehicle 300. Further, the vehicle 300 may take the form of a truck (e.g., vehicle 100 shown in FIG. 1) or an SUV (e.g., vehicle 200 shown in FIG. 2).

The vehicle 300 may include several lamps. For example, in one or more implementations, the vehicle 300 includes a lamp 320a, a lamp 320b, and a lamp 320c. Each of the lamps 320a, 320b, and 320c may include one or more lights sources designed to illuminate and increase visibility for passengers of the vehicle 300. For example, the lamp 320a includes a light source 322a, a light source, 322b, and a light source 322c. The light sources 322a, 322b, and 322c may be representative of additional light sources for the lamp 320a as well as the lamp 320c. Also, the lamp 320b may include a light source 324 representative of one or more light sources. Each of the described light sources may take the form of an LED or an incandescent bulb, as non-limiting examples. The lamps 320a and 320c may each be referred to as a headlight or head lamp, and the lamp 320b may be referred to as a center lamp. The vehicle 300 may further include a power supply (not shown in FIG. 3), such as a battery pack (e.g., similar to the battery pack 102 shown in FIG. 1), that provides energy (e.g., electrical energy) that causes the light sources 322a, 322b, 322c, and 324 to illuminate.

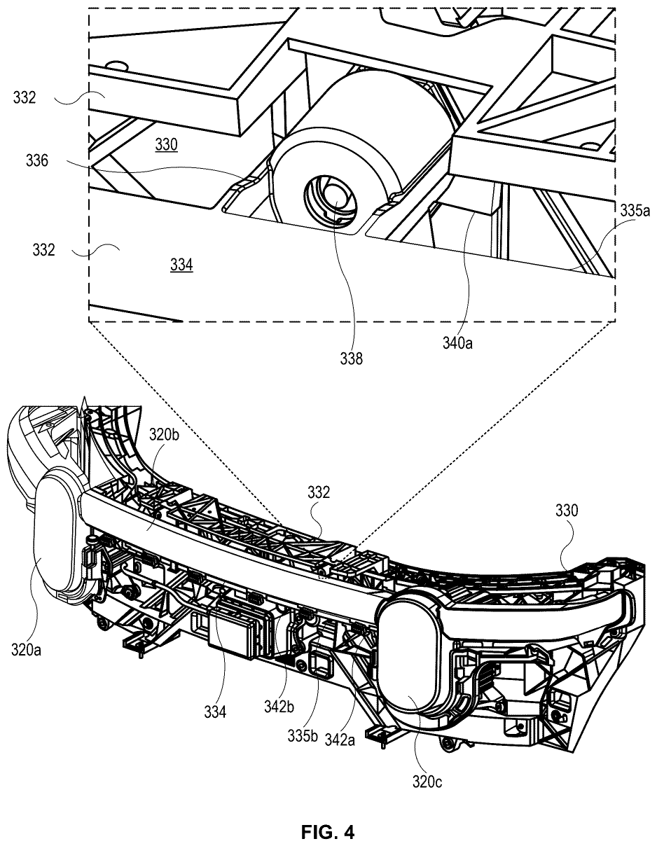

FIG. 4 illustrates a perspective view of an example a carrier 330 for lamps, in accordance with aspects of the present disclosure. The carrier 330 is designed for use in a vehicle (e.g., vehicle 100 shown in FIG. 1, vehicle 200 shown in FIG. 2) to hold the lamps 320a, 320b, and 320c. The carrier 330 may be designed (e.g., molded, stamped) to conform to a shape of a vehicle (e.g., front end 106 of the vehicle 100 shown in FIG. 1, front end 206 of the vehicle 200 shown in FIG. 2). The carrier 330 may carry several additional components for a vehicle.

Additionally, a bracket 332 may be coupled with (e.g., fastened to) the carrier 330. The bracket 332 is designed to couple with a lamp housing 334 that carries (e.g., holds) the lamp 320b. For example, as shown in the enlarged view, the lamp housing 334 includes a wall 335a and an extension 336 that extends from the wall 335a. The extension 336 may receive a fastener 338 (e.g., bolt). The bracket 332 may include a tab 340a through which the fastener 338 passes, thereby allowing the bracket 332 to couple with the carrier 330. The carrier 330, the bracket 332, and the lamp housing 334 (as well as the lamp 320b) may form an assembly, or subassembly, for vehicles. Although not shown, the lamp housing 334 may include an additional extension similar to the extension 336 and the bracket 332 may include an additional tab similar to the tab 340a. In this regard, the bracket 332 and the lamp housing 334 may couple together at an additional location via the additional extension, the additional tab, and an additional fastener. In one or more implementations, the bracket 332 includes two tabs (e.g., upper tabs).

While an upper region of the lamp housing 334 is designed to couple with the bracket 332, a lower region (e.g., opposite the upper region) of the lamp housing 334 is designed to couple with the carrier 330. For example, the lamp housing 334 may include a wall 335b and a tab 342a and a tab 342b (representative of one or more additional tabs of the lamp housing 334) extending from the wall 335b, each of which is designed to receive a fastener (not shown in FIG. 4). In one or more implementations, the lamp housing 334 includes four tabs (e.g., lower tabs). Also, the wall 335a may be separate from the wall 335b, and vice versa.

In the event of an applied force to the lamp housing 334, the lamp housing 334, including the lamp 320b, may be designed to move relative to other components. For example, when an applied force to the lamp housing 334 is sufficient to break, or sever, the tab 340a representative of one or more additional tabs) of the bracket 332 as well as the tabs 342a and 342b (representative of one or more additional tabs) of the lamp housing 334, movement of the lamp housing 334, including the lamp 320b, relative to the lamps 320a and 320b, carrier 330, and the bracket 332 is permitted. This will be shown and described below.

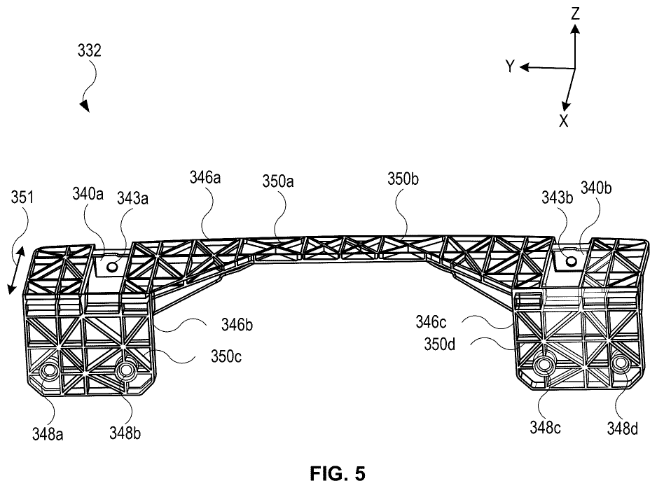

FIG. 5 illustrates a perspective view of an example a bracket 332 for securing lamps of a vehicle, in accordance with aspects of the present disclosure. The bracket 332 may take the form of an apparatus for use with the carrier 332 and the lamp housing 334 (both shown in FIG. 4). The bracket 332 may include materials such as plastic (e.g., thermoplastic) and may further include embedded glass (e.g., fiber glass). Further, the bracket 332 may be formed through an operation(s) including molding (e.g., over-molding) and stamping, as non-limiting examples.

As shown, the bracket 332 includes a portion 346a, a portion 346b, and a portion 346c. Each of the portions 346a, 346b, and 346c may be referred to as a bracket portion. In one or more implementations, the portion 346a is perpendicular with respect to the portions 346b and 346c, and vice versa. In addition to the tab 340a, the bracket 332 may further include a tab 340b. Each of the tabs 340a and 340b may be utilized to secure with a carrier (e.g., carrier 330 shown in FIG. 4), and moreover, may be designed to break in response to an applied force to a lamp or lamp housing (e.g., lamp 320b, lamp housing 334 shown in FIG. 4). Each of the tabs 340a and 340b may extend from the portion 346a of the bracket 332. Also, the tab 340a and the tab 340b may include an opening 343a and an opening 343b, respectively, each of which is designed to receive a fastener (e.g., fastener 338 shown in FIG. 4) to couple the portion 346a with a carrier. In one or more implementations, each of the tabs 340a and 340b is perpendicular with respect to the portion 346a of the bracket 332. Also, in one or more implementations, each of the tabs 340a and 340b is parallel with respect to the portion 346c and the portion 346b of the bracket 332. Also, as shown, the portion 346b is separate from the portion 346c along the Y axis.

Additionally, the portion 346b may include one or more openings. For example, the portion 346b may include an opening 348a and an opening 348b, each of which is designed to receive a fastener (e.g., fastener 338 shown in FIG. 4) to couple the portion 346b with a carrier. Similarly, the portion 346c may include an opening 348c and an opening 348d, each of which is designed to receive a fastener (e.g., fastener 338 shown in FIG. 4) to couple the portion 346b with a carrier.

During an impact event (e.g., to the lamp 320b shown in FIG. 4) that causes the tabs 340a and 340b to break, the lamp 320b may move relative to the portions 346a, 346b, and 346c. In this regard, the tab 340a and the portion 346b define a separation 351. The lamp 320b may travel a distance defined by the separation 351. In this regard, the separation 351 may define in part a space (e.g., three-dimension space) for movement/travel of the lamp 320b. The separation 351 may define the same or similar distance between the tab 340b and the portion 346c.

In order to provide enhanced resistance to applied forces along the Z-axis, the portion 346a may include several ribs. For example, the portion 346a may include a rib 350a and a rib 350b (representative of one or more ribs). The ribs 350a and 350b may provide added strength and reinforcement to the portion 346a. In this regard, certain components (e.g., the tabs 340a and 340b) of the bracket 332 may be designed to break from an applied force (e.g., along the X-axis), while other components (e.g., the portion 346a) of the bracket 332 may be designed to resist breaking from an applied force (e.g., along the Z-axis). In one or more implementations, each of the portions 346b and 346c include one or more ribs similar to the ribs 350a and 350b. For example, the portion 346b and the portion 346c include a rib 350c and a rib 350d, respectively.

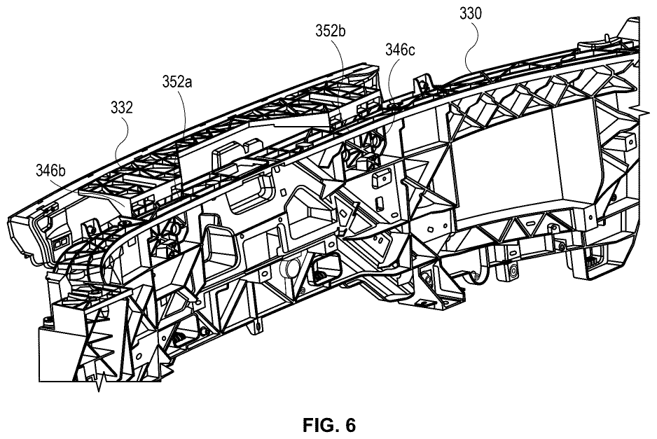

FIG. 6 illustrates a partial perspective view of the carrier 330 and the bracket 332 coupled with the carrier, further showing relationships between the carrier 330 and the bracket 332, in accordance with aspects of the present disclosure. The carrier 330 may include an opening 352a and an opening 352b (e.g., slots) through which the portion 346b and the portion 346c, respectively, pass. The openings 352a and 352b may provide additional securing locations for the bracket 332.

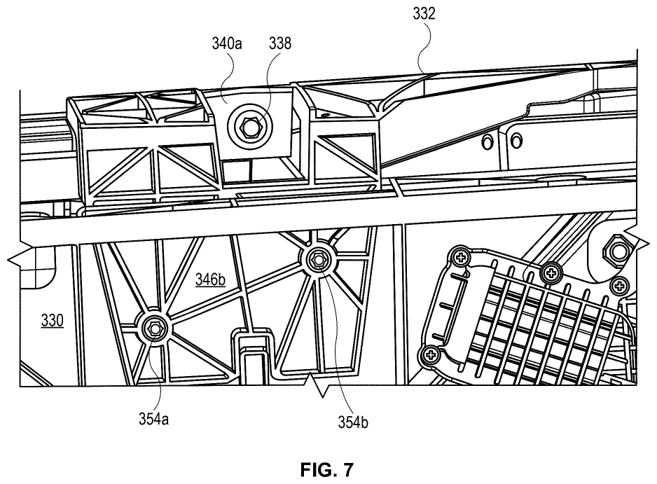

FIG. 7 illustrates a partial perspective view of the carrier 330 and the bracket 332 coupled with the carrier 330, further showing the portion 346b of the bracket 332 coupled with the carrier 330, in accordance with aspects of the present disclosure. The fastener 338 may secure the tab 340a with the carrier 330. Although not shown, an additional fastener may secure the tab 340b (shown in FIG. 5) with the carrier 330. Additionally, the portion 346b of the bracket 332 may secure with the carrier 330 via fasteners. For example, a fastener 354a and a fastener 354b mass pass through respective openings (e.g., openings 348a and 348b shown in FIG. 5). The portion 346c of the bracket 332 (shown in FIG. 5) may secure with the carrier 330 in a similar manner as that of the portion 346b.

In one or more implementations, at least some of an applied force to the lamp 320b (shown in FIG. 3) may be transferred to the carrier 330 and the bracket 332, causing the tab 340a and the tab 340b (shown in FIG. 5) to break. This may cause the lamp 320b and the lamp housing 334 (shown in FIG. 4) to move relative to the carrier 330 and the bracket 332. However, the bracket 332, including the portion 346b (representative of the portion 346c shown in FIG. 5) may remain coupled with (i.e., unbroken) the carrier 330.

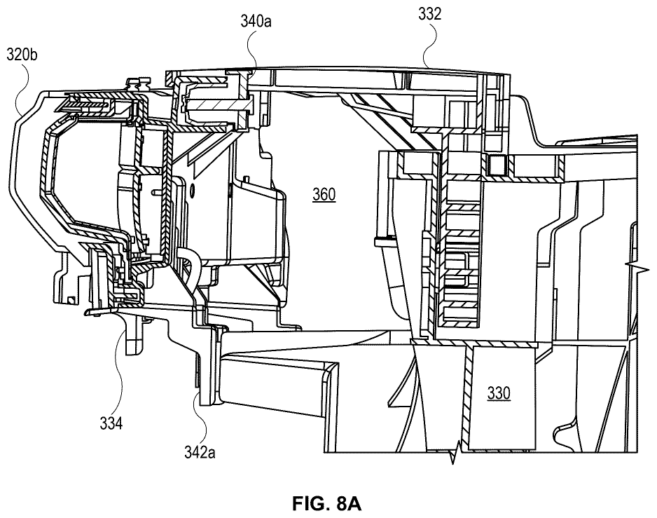

FIG. 8A illustrates a partial cross sectional view of a carrier 330 and a bracket 332, further showing a lamp housing 334 coupled with the carrier 330 and the bracket 332, in accordance with aspects of the present disclosure. As shown, the lamp housing 334 is carrying the lamp 320b. The lamp housing 334 is coupled with the bracket 332 via the tab 340a (representative of the tab 340b shown in FIG. 5). Additionally, the tab 342a (representative of additional tabs shown in FIG. 4, including the tab 342b) of the lamp housing 334 may couple the lamp housing 334 with the carrier 330. Based on the coupling between the lamp housing 334 and the carrier 330, as well as between the lamp housing 334 and the bracket 332, the carrier 330 may define a volume 360 (e.g., space, gap) through which the lamp housing 334 may at least partially pass in the event of an applied force to the lamp 320b and/or the lamp housing 334.

FIG. 8B illustrates a partial cross sectional view of the carrier 330 and the bracket 332 shown in FIG. 8A, further showing movement of the lamp 320b and the lamp housing 334 based on an applied force, in accordance with aspects of the present disclosure. Based on an applied force (e.g., in the direction of the arrow 362), several tabs may break. For example, the tab 340a (representative of the tab 340b shown in FIG. 5) of the bracket 332 may break. Additionally, the tab 342a (representative of additional tabs shown in FIG. 4, including the tab 342b) of the lamp housing 334 may break. The breaking of the aforementioned tabs may permit movement of both the lamp 320b and the lamp housing 334 relative to the carrier 330 and the bracket 332. Also, both the lamp 320b and the lamp housing 334 may move relative to the lamps 320a and 320b (shown in FIG. 3). Further, the lamp housing 334 (and in some cases, the lamp 320b) may enter, or at least partially enter, the volume 360. When a pedestrian causes the applied force, the movement of the lamp 320b and the lamp housing 334 may minimize the impact/injury to the pedestrian. Beneficially, vehicles incorporating the features of the carrier 330, the bracket 332, and the lamp housing 334 may provide a safer experience for pedestrians.

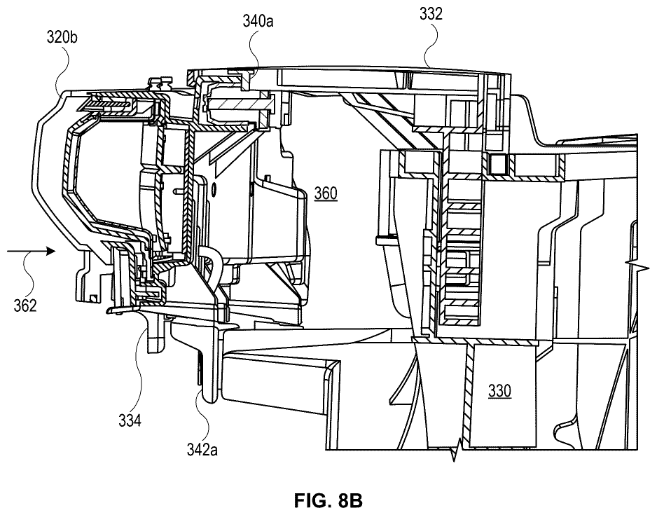

FIG. 9 illustrates a perspective view of an example of a body 470 used to absorb impact energy, in accordance with aspects of the present disclosure. The body 470 may be designed and positioned in vehicles to absorb impact. For example, based on the position of the body 470 in a vehicle, the body 470 may absorb and reduce impact force for pedestrian pelvis impact.

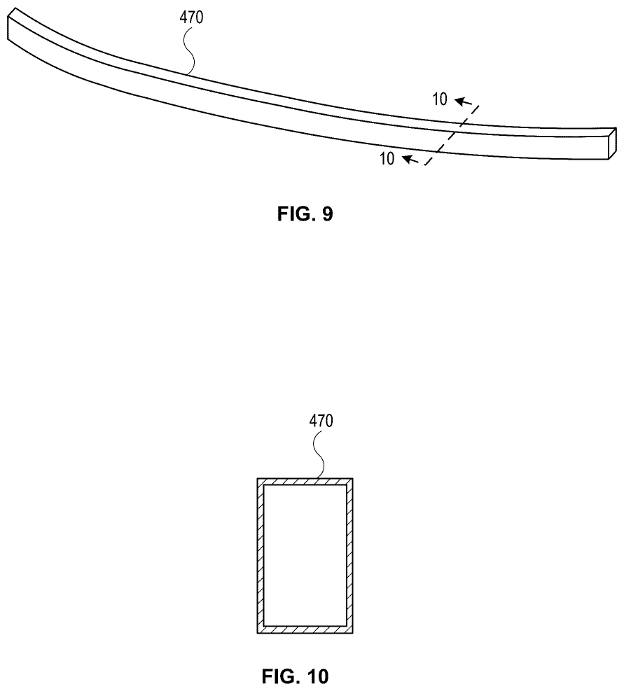

FIG. 10 illustrates a cross sectional view of the body 470 shown in FIG. 9, taken along line 10-10, in accordance with aspects of the present disclosure. As shown, the body 470 may take the form of a hollow, rectangular body.

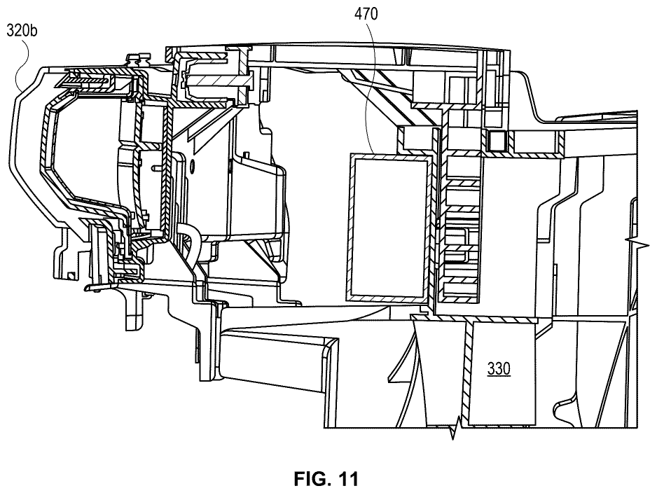

FIG. 11 illustrates a partial cross sectional view of the lamp 320b and the carrier 330, further showing the body 470 positioned relative to the lamp 320b, in accordance with aspects of the present disclosure. As shown, the body 470 is coupled with, and carried by, the carrier 330. The body 470 may be located behind the lamp 320b. In this regard, an impact force to the lamp 320b may be absorbed, or at least partially absorbed, by the body 470. Also, the body 470 may be positioned relative to the lamp 320b to form a gap between the body 470 and the lamp 320b. As a non-limiting example, the gap may be approximately in the range of 10-20 millimeters (mm). In one or more implementations, the gap is 15 mm.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

1. An apparatus, comprising:
a bracket comprising:
a first portion comprising a first tab configured to receive a first fastener to couple a lamp housing with the first portion,
a second tab extending from the first portion,
a second portion extending from the first portion, the second portion configured to couple with a carrier, wherein in response to an applied force, the first tab is configured to break and permit movement of the lamp housing relative to the first portion and the second portion, wherein the first tab is i) perpendicular with respect to the first portion and ii) parallel with respect to the second portion, and
a third portion extending from the first portion and separate from the second portion, wherein the second tab is i) perpendicular with respect to the first portion and ii) parallel with respect to the third portion.

2. The apparatus of claim 1, wherein the first portion is perpendicular with respect to the second portion.

3. The apparatus of claim 1, wherein the first tab comprises an opening to receive the first fastener.

4.-5. (canceled)

6. The apparatus of claim 1, wherein the first portion comprises one or more ribs.

7. The apparatus of claim 1, wherein:
the first tab and the second portion define a separation, and
in response to the applied force that causes the first tab to break, the separation defines a space for the movement of the lamp housing.

8. The apparatus of claim 1, wherein the second portion comprises an opening configured to receive a second fastener to secure the bracket with the carrier.

9. A subassembly, comprising:
a bracket comprising a bracket tab;
a lamp housing configured to couple with the bracket via a first fastener passing through the bracket tab, the lamp housing comprising:
a lamp housing tab,
a first wall,
an extension that extends from the first wall, the extension configured to couple with the first fastener, and
a second wall separate from the first wall, wherein the lamp housing tab extends from the second wall; and
a carrier configured to couple with the bracket and hold the lamp housing, wherein in response to an applied force, the bracket tab and the lamp housing tab are configured to break and permit movement of the lamp housing relative to the bracket.

10. (canceled)

11. The subassembly of claim 9, wherein the bracket further comprises:
a first bracket portion, wherein the bracket tab extends from the first bracket portion; and
a second bracket portion extending from the first bracket portion, wherein the lamp housing tab extends from the second bracket portion.

12. The subassembly of claim 11, wherein the first bracket portion is perpendicular with respect to the second bracket portion.

13. The subassembly of claim 11, wherein the bracket tab is perpendicular with respect to the first bracket portion.

14. The subassembly of claim 11, wherein the bracket tab is parallel with respect to the second bracket portion.

15. The subassembly of claim 11, wherein the first bracket portion comprises one or more ribs.

16. The subassembly of claim 11, wherein:
the bracket tab defines a separation from the first bracket portion, and
in response to the applied force that causes the first bracket tab and the lamp housing tab to break, the separation defines a space for the movement of the lamp housing.

17. A vehicle, comprising:
a vehicle body;
a bracket disposed in the vehicle body, the bracket comprising a first tab;
a lamp housing disposed in the vehicle body, the lamp housing configured to couple with the bracket via a first fastener passing through the first tab, the lamp housing comprising:
a housing that includes a second tab,
a first wall;
an extension that extends from the first wall, the extension configured to couple with the first fastener; and
a second wall separate from the first wall, wherein the second tab extends from the second wall; and
a carrier disposed in the vehicle body, the carrier configured to couple with the bracket and hold the lamp housing, wherein in response to an applied force, the first tab and the second tab are configured to break and permit movement of the lamp housing relative to the bracket.

18. (canceled)

19. The vehicle of claim 17, further comprising a lamp carried by the lamp housing, wherein the vehicle comprises an opening for the lamp.

20. The vehicle of claim 17, wherein the bracket further comprises:
a first bracket portion, wherein the first tab extends from the first bracket portion; and
a second bracket portion extending from the first bracket portion, wherein the second tab extends from the second bracket portion.

21. The vehicle of claim 17, further comprising a hollow body configured to absorb impact.

22. The subassembly of claim 11, further comprising a rectangular body configured to absorb impact.

23. The apparatus of claim 1, wherein the first portion, the second portion, and the third portion comprise a plastic.

24. The apparatus of claim 23, wherein the first portion, the second portion, and the third portion further comprise embedded fibers in the plastic.

25. The apparatus of claim 24, wherein the second portion and the third portion are configured to extend through respective openings in the carrier, the openings providing additional attachment locations for securing the bracket to the carrier.

26. The apparatus of claim 1, wherein the second portion and the third portion are configured to extend through respective openings in a carrier coupled to the bracket, the openings providing additional attachment locations for securing the bracket to the carrier.
